(19) United States
(12) Patent Application Publication
(10) Pub. No.: US 2026/0359644 A1
(43) Pub. Date: Nov. 12, 2026

(54) METHOD, SERVER SYSTEM, AND COMPUTER-READABLE STORAGE MEDIUM FOR AUTOMATICALLY GENERATING INFERENCE DATA FOR LEARNING USING CONNECTORS

(71) Applicant: SELECT STAR, INC., Daejeon (KR)

(72) Inventors: BaRom Kang, Hwaseong-si (KR); Heondeuk Lee, Seoul (KR); Yonghoon Kwon, Seoul (KR)

(73) Assignee: SELECT STAR, INC., Daejeon (KR)

(21) Appl. No.: 19/256,681

(22) Filed: Jul. 1, 2025

(30) Foreign Application Priority Data
May 8, 2025 (KR) 10-2025-0059571

(51) Int. Cl. G06N 3/088; G06N 3/0475

(52) U.S. Cl. CPC G06N 3/088; G06N 3/0475

(57) ABSTRACT

The present invention relates to a method for automatically generating inference data for learning using connectors, a self-learning method of LLM and a system using the same, and a computer-readable storage medium, and more specifically, to a method for automatically generating inference data for learning using connectors, a self-learning method of LLM and a system using the same, and a computer-readable storage medium, which derives a first answer by inputting the task question extracted from a task dataset to an LLM, derives a second answer by inputting the corresponding task question, the first answer, and a connector to the LLM when the first answer is not a correct answer, and derives inference data for learning when the second answer is the correct answer.

### CROSS REFERENCE TO RELATED APPLICATION

The present application claims the right of priority to and the benefits of Korean Application No. 10-2025-0059571 having a filing date of May 08, 2025, the content of which is hereby incorporated by reference in its entirety.

### BACKGROUND OF THE INVENTION

### 1. Field of the Invention

The present invention relates to a method for automatically generating inference data for learning using connectors, self-learning method of LLM and system using the same, and a computer-readable storage medium, and more specifically, to a method for automatically generating inference data for learning using connectors, self-learning method of LLM and system using the same, and a computer-readable storage medium, which derives a first answer by inputting the task question extracted from a task dataset to an LLM, derives a second answer by inputting the corresponding task question, the first answer, and a connector to the LLM when the first answer is not a correct answer, and derives inference data for learning when the second answer is the correct answer.

### 2. Description of the Prior Art

Recently, a test-time scaling method has attracted attention due to difficulty in expansion at a training time point. Representatively, the o1 model of OpenAI showed high performance through this method, but a specific method for implementation was not disclosed yet, thus many studies were conducted to attempt an approach similar thereto, and in particular, reinforcement learning (RL) and Monte Carlo tree search (MCTS) techniques were used. However, these methods showed limitations due to a cost problem, which occurred in an inference process.

At this time, a study on S1: Simple Test-time Scaling published by Stanford demonstrated excellent performance by carrying out fine-tuning with only 1,000 high-quality inference datasets using a 32B model, and LIMO: Less is More for Reasoning solved a cold-start problem of a DeepSeek-R1 model utilizing 817 data and generated high-quality inference data through 1,000 dataset curation. If there is appropriate inference data obtained through the above study, it is possible to obtain a model that is trained to have excellent performance.

The existing inference dataset follows a method of simply deriving a correct answer in the process of solving a problem, but the high-quality inference dataset may provide a much longer and more detailed thinking process as if a real person were thinking, including additional thinking processes such as self-reflection, verification, and aha points, beyond simple derivation of correct answers. In other words, it is called a Long CoT dataset as data which requires more thinking and time to reach the correct answer.

However, it is very difficult for a person to directly generate such high-quality inference data, and a lot of effort is required to examine the quality of the generated inference data. Under this circumstance, there is a need to develop a technology for generating various inference data using connectors without a lot of resources and gradually advancing an LLM by self-learning through the inference data.

### SUMMARY OF THE INVENTION

An object of the present invention is to provide a method for automatically generating inference data for learning using connectors, self-learning method of LLM and system using the same, and a computer-readable storage medium, and more specifically, to a method for automatically generating inference data for learning using connectors, self-learning method of LLM and system using the same, and a computer-readable storage medium, which derives a first answer by inputting the task question extracted from a task dataset to an LLM, derives a second answer by inputting the corresponding task question, the first answer, and a connector to the LLM when the first answer is not a correct answer, and derives inference data for learning when the second answer is the correct answer.

To solve the problem described above, one embodiment of the present invention may provide a method for automatically generating inference data for learning using connectors performed in a server system including one or more processors and one or more memories, the method including: a task question extracting step of extracting a plurality of task questions from a task dataset including a task question and a task correct answer corresponding to the task question; a first answer deriving step of deriving a first answer by inputting the extracted task question to an LLM outside or inside the server system; a first answer verifying step of comparing the first answer with a task correct answer corresponding to the extracted task question to determine whether the first answer is a correct answer or not; a second answer deriving step of deriving a second answer by inputting the task question, the first answer, and a first connector randomly determined among a plurality of predetermined connectors to the LLM when the first answer is not the correct answer; and a second answer verifying step of comparing the second answer with the task correct answer to determine whether the second answer is the correct answer or not.

In one embodiment of the present invention, the method for automatically generating inference data for learning may further include: a third answer deriving step of deriving a third answer by inputting the task question, the first answer, the first connector, the second question, and a second connector randomly determined among a plurality of predetermined connectors to the LLM when the second answer is not the correct answer; and a third answer verifying step of comparing the third answer with the task correct answer to determine whether the third answer is the correct answer or not.

In one embodiment of the present invention, the second answer verifying step may include configuring the task question, the first answer, the first connector, and the second answer as a set to derive inference data for learning when the second answer is the correct answer, and the method for automatically generating inference data for learning may further include a learning step of training the LLM using the inference data for learning.

In one embodiment of the present invention, the second answer verifying step may include configuring the task question, the first answer, the first connector, and the second answer as a set to derive inference data for learning when the second answer is the correct answer, and the method for automatically generating inference data for learning may further include a learning step of training a target model other than the LLM using the inference data for learning.

In one embodiment of the present invention, the method for automatically generating inference data for learning may detect a task question, from which an answer other than the correct answer is derived, by inputting each of the plurality of task questions included in the task dataset to the LLM, and drive a corrected answer by applying each of the plurality of predetermined connectors to each of the detected task questions, in which the plurality of connectors may be classified into a connector, which derives an answer which is the correct answer, and a connector, which derives an answer other than the correct answer, based on the corrected answer.

In one embodiment of the present invention, the method for automatically generating inference data for learning may generate a plurality of branch nodes by applying each connector to an answer other than the correct answer among the answers derived from the LLM with regard to the plurality of predetermined connectors, and form a tree by repeatedly applying each of the connectors to a branch node including an answer other than the correct answer among the plurality of branch nodes to generate a plurality of branch nodes, in which the plurality of branch nodes may be classified into a node including an answer which is the correct answer, and a node including an answer other than the correct answer.

In one embodiment of the present invention, the method for automatically generating inference data for learning may generate branch nodes until the tree reaches a predetermined depth, and then detect a leaf node including an answer which is the correct answer from among leaf nodes of the corresponding tree, and configure a path ranging from the detected leaf node to a root node as one set to derive inference data for learning.

To solve the problem described above, one embodiment of the present invention may provide a server system including one or more processors and one or more memories and configured to perform a method for automatically generating inference data for learning using connectors, the server system including: a task question extracting module configured to extract a plurality of task questions from a task dataset including a task question and a task correct answer corresponding to the task question; a first answer deriving module configured to derive a first answer by inputting the extracted task question to an LLM outside or inside the server system; a first answer verifying module configured to compare the first answer with a task correct answer corresponding to the extracted task question to determine whether the first answer is a correct answer or not; a second answer deriving step of deriving a second answer by inputting the task question, the first answer, and a first connector randomly determined among a plurality of predetermined connectors to the LLM when the first answer is not the correct answer; and a second answer verifying module configured to compare the second answer with the task correct answer to determine whether the second answer is the correct answer or not.

To solve the problem described above, one embodiment of the present invention may provide a computer-readable storage medium configured to implement a method for automatically generating inference data for learning using connectors performed in a server system including one or more processors and one or more memories, the computer-readable storage medium including: computer-executable instructions which cause the server system to perform following steps of: a task question extracting step of extracting a plurality of task questions from a task dataset including a task question and a task correct answer corresponding to the task question; a first answer deriving step of deriving a first answer by inputting the extracted task question to an LLM outside or inside the server system; a first answer verifying step of comparing the first answer with a task correct answer corresponding to the extracted task question to determine whether the first answer is a correct answer or not; a second answer deriving step of deriving a second answer by inputting the task question, the first answer, and a first connector randomly determined among a plurality of predetermined connectors to the LLM when the first answer is not the correct answer; and a second answer verifying step of comparing the second answer with the task correct answer to determine whether the second answer is the correct answer or not.

According to one embodiment of the present invention, there may be an effect of automatically generating inference data for learning using task datasets and connectors.

According to one embodiment of the present invention, there may be an effect of enabling self-learning of an LLM through inference data for learning.

According to one embodiment of the present invention, there may be an effect of deriving a corrected answer by applying a connector when the LLM derives an answer other than a correct answer for an inputted task question.

According to one embodiment of the present invention, there may be an effect of deriving inference data for learning when the LLM derives an answer which is the correct answer for the inputted task question.

According to one embodiment of the present invention, there may be an effect of learning the LLM and a target model using the inference data for learning.

According to one embodiment of the present invention, there may be an effect of generating a branch node by applying a connector to an answer other than the correct answer among the answers derived from the LLM.

According to one embodiment of the present invention, there may be an effect of generating a tree including the branch node based on a plurality of connectors, and deriving the inference data for learning based on the corresponding tree.

According to one embodiment of the present invention, there may be an effect of automatically generating inference data which satisfies diversity and quality using connectors.

According to one embodiment of the present invention, there may be an effect of developing a model with continuous performance on excellent inference through self-learning of the LLM.

### BRIEF DESCRIPTION OF THE DRAWINGS

FIG. 1 schematically shows an internal configuration of a server system according to one embodiment of the present invention.

FIG. 2 schematically shows a step of performing a method for automatically generating inference data for learning according to one embodiment of the present invention.

FIG. 3 schematically shows a process of performing a task question extracting step according to one embodiment of the present invention.

FIG. 4 schematically shows a process of performing a first answer deriving step according to one embodiment of the present invention.

FIGS. 5A and 5B schematically show a process of performing a second answer deriving step and a second answer verifying step according to one embodiment of the present invention.

FIG. 6 schematically shows inference data for learning according to one embodiment of the present invention.

FIG. 7 schematically shows a process of performing a step of generating a branch node according to one embodiment of the present invention.

FIGS. 8A and 8B schematically show a process of performing a learning step according to one embodiment of the present invention.

FIG. 9 schematically shows internal components of the computing device according to one embodiment of the present invention.

### DETAILED DESCRIPTION OF THE EXEMPLARY EMBODIMENTS

Hereinafter, various embodiments and/or aspects will be described with reference to the drawings. In the following description, numerous specific details are set forth in order to provide a thorough understanding of one or more aspects for the purpose of explanation. However, it will also be appreciated by a person having ordinary skill in the art that such aspect(s) may be carried out without the specific details. The following description and accompanying drawings will be set forth in detail for specific illustrative aspects among one or more aspects. However, the aspects are merely illustrative, some of various ways among principles of the various aspects may be employed, and the descriptions set forth herein are intended to include all the various aspects and equivalents thereof.

In addition, various aspects and features will be presented by a system that may include a plurality of devices, components and/or modules or the like. It will also be understood and appreciated that various systems may include additional devices, components and/or modules or the like, and/or may not include all the devices, components, modules or the like recited with reference to the drawings.

The term “embodiment”, “example”, “aspect”, “exemplification”, or the like as used herein may not be construed in that an aspect or design set forth herein is preferable or advantageous than other aspects or designs. The terms 'unit', 'component', 'module', 'system', 'interface' or the like used in the following generally refer to a computer-related entity, and may refer to, for example, hardware, software, or a combination of hardware and software.

In addition, the terms "include" and/or "comprise" specify the presence of the corresponding feature and/or component, but do not preclude the possibility of the presence or addition of one or more other features, components or combinations thereof.

In addition, the terms including an ordinal number such as first and second may be used to describe various components, however, the components are not limited by the terms. The terms are used only for the purpose of distinguishing one component from another component. For example, the first component may be referred to as the second component without departing from the scope of the present invention, and similarly, the second component may also be referred to as the first component. The term "and/or" includes any one of a plurality of related listed items or a combination thereof.

In addition, in embodiments of the present invention, unless defined otherwise, all terms used herein including technical or scientific terms have the same meaning as commonly understood by those having ordinary skill in the art. Terms such as those defined in generally used dictionaries will be interpreted to have the meaning consistent with the meaning in the context of the related art, and will not be interpreted as an ideal or excessively formal meaning unless expressly defined in the embodiment of the present invention.

The "user terminal" referred to below may be implemented as a computer or portable terminal that can access a server or other terminals through a network. The computer may include, for example, a notebook computer, a desktop, a laptop, and the like installed with a web browser, and the portable terminal may include all kinds of handheld-based wireless communication device such as smartphone, personal communication system (PCS), global system for mobile communications (GSM), personal digital cellular (PDC), personal handyphone system (PHS), personal digital assistant (PDA), international mobile telecommunication (IMT)-2000, code division multiple access (CDMA)-2000, W-code division multiple access (W-CDMA), wireless broadband internet (Wibro), or bluetooth low energy (BLE) beacon terminal. In addition, "network" may be implemented by a wired network such as a local area network (LAN), a wide area network (WAN) or a value added network (VAN), and all types of wireless network such as a mobile radio communication network, or a satellite network.

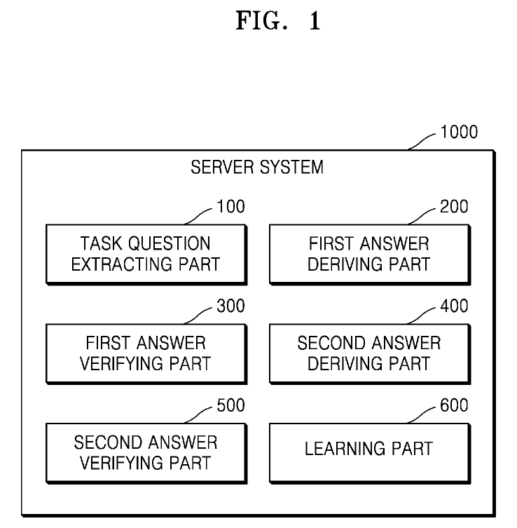

FIG. 1 schematically shows an internal configuration of a server system 1000 according to one embodiment of the present invention.

As shown in FIG. 1, the server system 1000 may include: a task question extracting module (i.e., a task question extracting part) 100 configured to perform a task question extracting step of extracting a plurality of task questions from a task dataset including a task question and a task correct answer corresponding to the task question; a first answer deriving module (i.e., a first answer deriving part) 200 configured to perform a first answer deriving step of deriving a first answer by inputting the extracted task question to an LLM 2000 outside or inside the server system 1000; a first answer verifying module (i.e., a first answer verifying part) 300 configured to perform a first answer verifying step of comparing the first answer with a task correct answer corresponding to the extracted task question to determine whether the first answer is a correct answer or not; a second answer deriving module (i.e., a second answer deriving part) 400 configured to perform a second answer deriving step of deriving a second answer by inputting the task question, the first answer, and a first connector randomly determined among a plurality of predetermined connectors to the LLM 2000 when the first answer is not the correct answer; a second answer verifying module (i.e., a second answer verifying part) 500 configured to perform a second answer verifying step of comparing the second answer with the task correct answer to determine whether the second answer is the correct answer or not; and a learning module (i.e., a learning module part) 600 configured to perform a learning step capable of training the LLM 2000 using the inference data for learning or training a target model 3000 other than the LLM 2000 using the inference data for learning.

Specifically, each component included in the server system 1000 shown in FIG. 1 may serve to control an operation of the server system 1000 which performs the method for automatically generating inference data for learning of the present invention.

More specifically, the task question extracting module 100 of the server system 1000 may include extracting a plurality of task questions from a task dataset including a task question and a task correct answer corresponding to the task question.

In one embodiment of the present invention, the task question extracting step may include extracting all the task questions included in the task dataset or randomly extracting the plurality of task questions from among all the task questions included in the task dataset.

The first answer deriving module 200 of the server system 1000 may include deriving a first answer by inputting the extracted task question to the LLM 2000 outside or inside the server system 1000.

In one embodiment of the present invention, the LLM 2000 may be located outside or inside the server system 1000, and may correspond to a model which derives a first answer including an answer to a corresponding task question when the task question is input. The first answer may include all the answers derived from the LLM 2000 in the first answer deriving step.

The first answer verifying module 300 of the server system 1000 may include comparing the first answer with a task correct answer corresponding to the extracted task question to determine whether the first answer is a correct answer or not.

In one embodiment of the present invention, the task question and the first answer may be configured as a set to derive inference data for learning when the first answer is the correct answer.

The second answer deriving module 400 of the server system 1000 may include deriving a second answer by inputting the task question, the first answer, and a first connector randomly determined among a plurality of predetermined connectors to the LLM 2000 when the first answer is not the correct answer.

In one embodiment of the present invention, the LLM 2000 may be located outside or inside the server system 1000, and may correspond to a model which derives a second answer including an answer to the corresponding task question when the task question, the task answer, and the first connector are input. The second answer may include all the answers derived from the LLM 2000 in the second answer deriving step. In this case, the LLM for deriving the first answer and the LLM for deriving the second answer may correspond to the same model.

The second answer verifying module 500 of the server system 1000 may include comparing the second answer with the task correct answer to determine whether the second answer is a correct answer or not.

In one embodiment of the present invention, the server system 1000 may further perform a third answer deriving step of deriving a third answer by inputting the task question, the first answer, the first connector, the second question, and a second connector randomly determined among a plurality of predetermined connectors to the LLM 2000 when the second answer is not the correct answer; and a third answer verifying step of comparing the third answer with the task correct answer to determine whether the third answer is the correct answer or not.

In this case, when the second answer is the correct answer, the task question, the first answer, the first connector, and the second answer may be configured as a set to derive inference data for learning.

The learning module 600 of the server system 1000 may train the LLM 2000 using the inference data for learning or train a target model 3000 other than the LLM 2000 using the inference data for learning.

In one embodiment of the present invention, the LLM 2000 may correspond to the LLM which derives the first answer and the second answer, the target model 3000 may be located outside or inside the server system 1000, and may correspond to a model to be trained with the inference data for learning as a model other than the LLM 2000, and the target model 3000 may include the LLM.

Preferably, the method for automatically generating inference data for learning of the present invention may detect a task question, from which an answer other than the correct answer is derived, by inputting each of the plurality of task questions included in the task dataset to the LLM outside or inside the server system, and derive a corrected answer by applying each of the plurality of predetermined connectors to each of the detected task questions, in which the plurality of connectors are classified into a connector, which derives an answer which is the correct answer, and a connector, which derives an answer other than the correct answer, based on the corrected answer.

In one embodiment of the present invention, the method for automatically generating inference data for learning may generate a plurality of branch nodes by applying each connector to an answer other than the correct answer among the answers derived from the LLM with regard to the plurality of predetermined connectors, and form a tree by repeatedly applying each of the connectors to a branch node including an answer other than the correct answer among the plurality of branch nodes to generate a plurality of branch nodes, in which the plurality of branch nodes may be classified into a node including an answer which is the correct answer, and a node including an answer other than the correct answer.

In addition, the method for automatically generating inference data for learning may generate branch nodes until the tree reaches a predetermined depth, and then detect a leaf node including an answer which is the correct answer from among leaf nodes of the corresponding tree, and configure a path ranging from the detected leaf node to a root node as one set to derive inference data for learning.

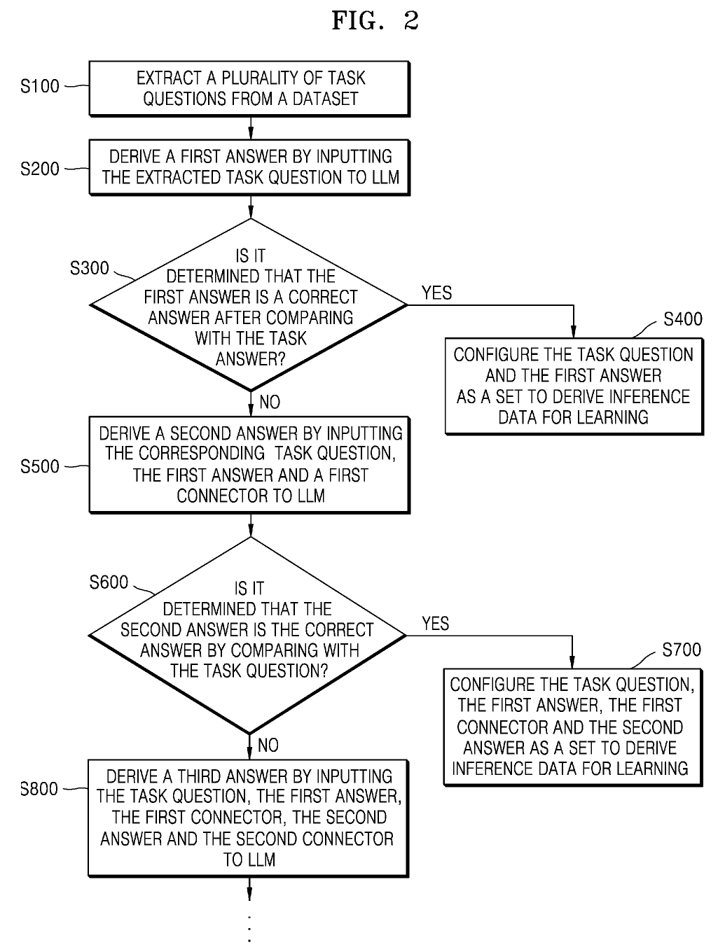

FIG. 2 schematically shows a step of performing a method for automatically generating inference data for learning according to one embodiment of the present invention.

As shown in FIG. 2, a plurality of task questions may be extracted from a task dataset including a task question and a task correct answer corresponding to the task question (S100), and a first answer may be derived by inputting any one task question of the extracted task questions to the LLM 2000 outside or inside the server system 1000 (S200).

In this case, the first answer may be compared with a task correct answer corresponding to the task question input in the LLM 2000 to determine whether the first answer is a correct answer or not, and when the first answer is the correct answer, the task question and the first answer may be configured as a set to derive inference data for learning (S400).

When the first answer is not the correct answer, a second answer may be derived by inputting the corresponding task question, the first answer, and a first connector randomly determined among a plurality of predetermined connectors to the LLM 2000 (S500).

In this case, the second answer may be compared with the task correct answer to determine whether the second answer is a correct answer or not (S600), and when the second answer is the correct answer, the task question, the first answer, the first connector, and the second answer may be configured as a set to derive inference data for learning (S700).

When the second answer is not the correct answer, a third answer may be derived by inputting the corresponding task question, the first answer, the first connector, the second answer, and one second connector randomly determined among a plurality of predetermined connectors except the first connector to the LLM 2000 (S800).

In this case, the third answer may be compared with the task correct answer to determine whether the third answer is a correct answer or not, and when the third answer is the correct answer, the task question, the first answer, the first connector, the second answer, the second connector, and the third answer may be configured as a set to derive inference data for learning.

When the third answer is not the correct answer, a fourth answer may be derived again by applying one third connector randomly determined among a plurality of predetermined connectors except the first connector and the second connector.

Thus, when an answer derived from the LLM 2000 is the correct answer based on the task correct answer, inference data for learning may be derived, and when it is not the correct answer, a process as in FIG. 2 may be repeated until the LLM 2000 derives the correct answer by repeatedly applying connectors.

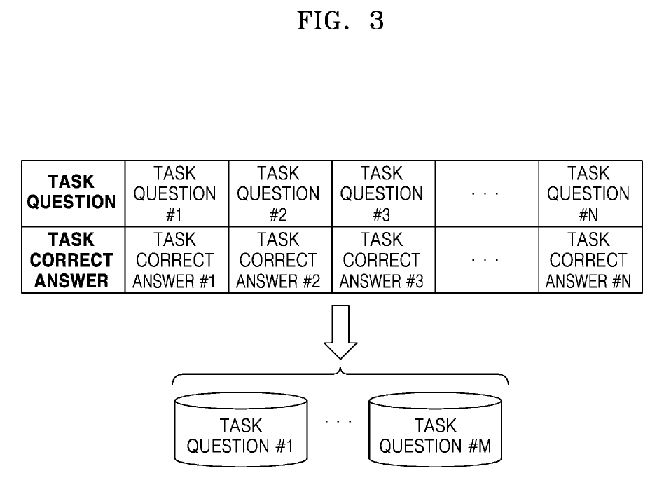

FIG. 3 schematically shows a process of performing a task question extracting step according to one embodiment of the present invention.

Schematically, the task question extracting step may include extracting a plurality of task questions from a task dataset including a task question and a task correct answer corresponding to the task question.

Specifically, the task dataset including the task question and the task correct answer may be stored in the server system 1000, and a plurality of task questions may be extracted from the task dataset in order to generate inference data for learning.

In one embodiment of the present invention, the task dataset may include a question used to evaluate a problem-solving ability, for example, mathematics, logic or the like such as AIME, AGIEval, and OmniMath, or an understanding ability, and an evaluation index of a correct answer type corresponding thereto. In addition, the task question and the task correct answer stored in the task dataset may be periodically updated through addition, correction, deletion and the like.

As shown in FIG. 3, task questions #1 to #N, and task answers #1 to #N corresponding to each task question may be stored in the task dataset of the server system 1000, and a plurality of task questions including task questions #1 to #M may be extracted.

In this case, the task correct answer may include an answer which is a correct answer for the task question corresponding thereto, each of N and M may correspond to a natural number of 1 or more, and N and M may correspond to the same natural number or different natural numbers. Thus, N may correspond to a natural number greater than M or equal to M.

For example, the task correct answer to the task question of "1+1=?" may correspond to "2", and all answers different from the task correct answer may correspond to wrong answers.

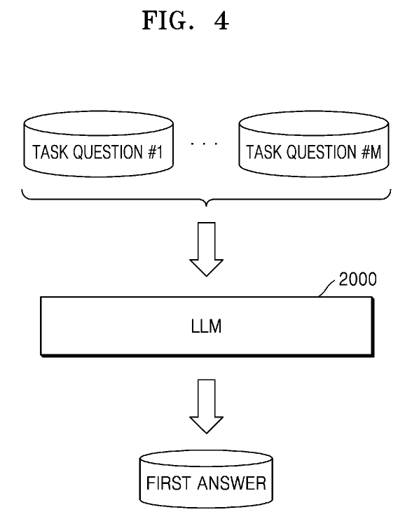

FIG. 4 schematically shows a process of performing a first answer deriving step according to one embodiment of the present invention.

Schematically, the first answer deriving step may include deriving a first answer by inputting the extracted task question to the LLM 2000 outside or inside the server system 1000.

Specifically, a first answer for each of task questions may be derived by inputting each of a plurality of extracted task questions to the LLM 2000, and a first answer for the corresponding task question may be derived by inputting any one of the plurality of extracted task questions to the LLM 2000.

As shown in FIG. 4, a first answer for each of task questions #1 to #M may be derived by inputting the task questions #1 to #M extracted in the task question extracting step to the LLM 2000 outside or inside the server system 1000. In this case, the first answer as in FIG. 4 may include first answers #1 to #M.

In one embodiment of the present invention, the first answer may include all the answers of the LLM 2000 for the input task question.

After that, the derived first answer may be compared with a task correct answer corresponding to the task question to determine whether the corresponding first answer is a correct answer or not. When the first answer #1 for the task question #1 is derived through the LLM 2000, the task correct answer #1 and the first answer #1 for the task question #1 stored in the task dataset may be compared to determine whether the first answer #1 is the correct answer or not.

In one embodiment of the present invention, the server system 1000 may be configured to determine whether the first answer #1 is the correct answer or not by comparing the task correct answer #1 and the first answer #1, or determine whether the first answer #1 is the correct answer or not by inputting the task correct answer #1 and the first answer #1 to the LLM outside or inside the server system 1000.

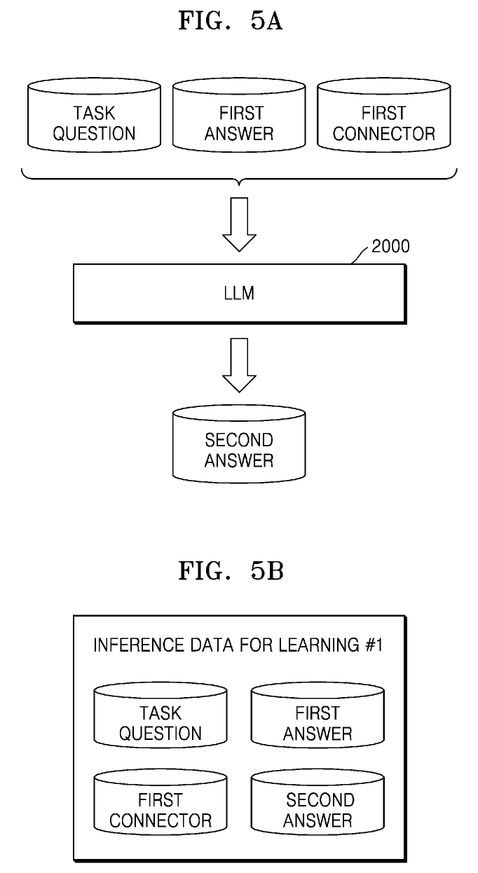

FIGS. 5A and 5B schematically show a process of performing a second answer deriving step and a second answer verifying step according to one embodiment of the present invention.

Schematically, FIG. 5A may show a process of performing the second answer deriving step, and FIG. 5B may show a process of performing the second answer verifying step.

Specifically, the second answer deriving step may include deriving a second answer by inputting the task question, the first answer, and a first connector randomly determined among a plurality of predetermined connectors to the LLM 2000 when the first answer is not the correct answer, and the second answer verifying step may include determining whether the second answer is the correct answer or not by comparing the second answer with the task correct answer.

In this case, when the second answer is not the correct answer, a third answer deriving step of deriving a third answer by inputting the task question, the first answer, the first connector, the second question, and a second connector randomly determined among a plurality of predetermined connectors to the LLM 2000; and a third answer verifying step of comparing the third answer with the task correct answer to determine whether the third answer is the correct answer or not may be performed in the server system 1000.

In addition, when the second answer is the correct answer, the task question, the first answer, the first connector, and the second answer may be configured as a set to derive inference data for learning.

As shown in FIG. 5A, when the first answer is not the correct answer, a second answer may be derived by inputting the task question, the first answer, and a first connector randomly determined among a plurality of predetermined connectors to the LLM 2000. In this case, the LLM used in the second answer deriving step may correspond to the same model as the LLM used in the first answer deriving step.

In one embodiment of the present invention, the second answer may include all answers of the LLM 2000 for a corresponding task question output based on the input task question, the first answer, and the first connector, and the plurality of predetermined connectors may include Oh, Wait, Wait a second, But hold on, Actually, On second thought, and the like.

In addition, the plurality of predetermined connectors may include a phrase which induces the LLM to derive an inference process, and in this case, the inference process may include various inference processes such as sequential development, re-evaluation, double check, hypothesis conversion, contradiction recognition, and the like.

For example, the connector as in the present invention may include Let's break this down one step at a time, which induces sequential development from the LLM, Hold on—let's re-evaluate our approach, which induces re-evaluation, Before moving forward, let's verify this step, which induces double check, Working backwards, we see that we need to, which induces hypothesis conversion, and Given this contradiction, we should revise our plan, which induces contradiction recognition.

After that, the derived second answer may be compared with a task correct answer corresponding to the task question to determine whether the corresponding second answer is a correct answer or not. In case the first answer #1 is not the correct answer after the first answer #1 for the task question #1 is derived through the LLM 2000, the task question #1, the first answer #1, and the randomly determined first connector may be input to the LLM 2000, and when the second answer #1 is derived through the LLM 2000, the task correct answer #1 for the task question #1 stored in the task dataset may be compared with the second answer #1 to determine whether the second answer #1 is the correct answer or not.

In one embodiment of the present invention, the server system 1000 may be configured to determine whether the second answer #1 is the correct answer or not by comparing the task correct answer #1 with the second answer #1, or determine whether the second answer #1 is the correct answer or not by inputting the task correct answer #1 and the second answer #1 to the LLM outside or inside the server system 1000.

In this case, the first connector may correspond to any one randomly determined among a plurality of predetermined connectors in the server system 1000, and the plurality of predetermined connectors in the server system 1000 may be updated.

As shown in FIG. 5B, when a second answer is the correct answer by determining whether the second answer is the correct answer or not through the second answer verifying step, the task question, the first answer, the first connector, and the second answer may be configured as a set to derive inference data for learning.

In one embodiment of the present invention, the LLM 2000 or a target model 3000 other than the LLM 2000 may be trained using the inference data for learning.

When a second answer is not the correct answer by determining whether the second answer is the correct answer or not through the second answer verifying step, a third answer may be derived by inputting the task question, the first answer, the first connector, the second question, and a second connector randomly determined among a plurality of predetermined connectors to the LLM 2000, and then the third answer may be compared with the task correct answer to determine whether the third answer is the correct answer or not.

In this case, the second connector may correspond to a connector different from the first connector, and may correspond to any one randomly determined among a plurality of predetermined connectors in the server system 1000 except the first connector.

Preferably, a new answer may be derived by applying a connector when an answer derived from the LLM 2000 is not the correct answer, and a process of deriving a new answer again may be repeated by additionally applying new connectors when the new answer is not the correct answer, too. As described above, the process of deriving an answer may be repeated by additionally applying new connectors until an answer which is the correct answer is derived.

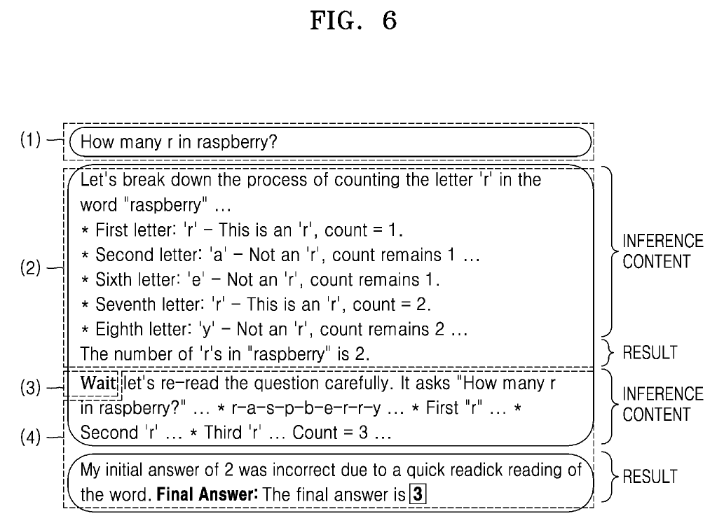

FIG. 6 schematically shows inference data for learning according to one embodiment of the present invention.

Schematically, the method for automatically generating inference data for learning may detect a task question, from which an answer other than the correct answer is derived, by inputting each of the plurality of task questions included in the task dataset to the LLM outside or inside the server system, and derive a corrected answer by applying each of the plurality of predetermined connectors to each of the detected task questions, in which the plurality of connectors may be classified into a connector, which derives an answer which is the correct answer, and a connector, which derives an answer other than the correct answer, based on the corrected answer.

In one embodiment of the present invention, a task question, which derives an answer other than the correct answer, may be detected by inputting each of the plurality of task questions included in the task dataset to the LLM to derive the corresponding task question and the corresponding answer as an incorrect answer, a plurality of corrected answers may be derived by applying any one of a plurality of predetermined connectors to a sample of the incorrect answer and the corrected answer may be compared with a task correct answer corresponding to the corresponding task question to determine whether the correct answer is the correct answer or not.

In this case, when the corrected answer is not the correct answer, a corrected answer may be additionally derived by applying another one of the plurality of connectors to the corresponding sample of incorrect answer and the corresponding corrected answer, and when the corrected answer is the correct answer, the corresponding task question, the corresponding answer, the corresponding connector, and the corresponding corrected answer may be configured as a set to derive inference data for learning.

As shown in FIG. 6, the inference data for learning may be automatically generated through the method for automatically generating inference data for learning of the present invention. In FIG. 6, (1) may correspond to a task question, (2) may correspond to a first answer, (3) may correspond to a first connector, and (4) may correspond to a second answer.

When a task question "How many r in raspberry" is input to the LLM 2000 as in (1), the first answer as in (2) may be output. In this case, when the task correct answer corresponding to the corresponding task question is "3", the answer "2" may be output in (2) and thus it may be determined that the corresponding first answer is not the correct answer.

Preferably, when the first answer is not the correct answer, all of the corresponding task question, the first answer, and the first connector corresponding to (1) to (3) may be input again to the corresponding LLM 2000 so as to derive the second answer.

Thus, when all of (1) to (3) are input to the LLM 2000 by applying the first connector "wait" as in (3), the second answer as in (4) may be output. In this case, the task correct answer corresponding to the corresponding task question may be "3" and the answer "3 may be output in (4), and thus it may be determined that the corresponding second answer is the correct answer.

After that, all of the task question, the first answer, the first connector, and the second answer corresponding to (1) to (4) may be configured as one set to derive inference data for learning. In other words, all of (1) to (4) may correspond to one inference data for learning.

In one embodiment of the present invention, each of the answers including the first answer and the second answer may include an inference content and a result, the inference content may include a process for deriving the corresponding answer, and the result may include an answer for the corresponding task question.

For example, with respect to the task question "How many r in raspberry" in FIG. 6, the first answer "2" may be consequently derived through the same process as in the inference content of (2), and in this case, "2" may correspond to the result.

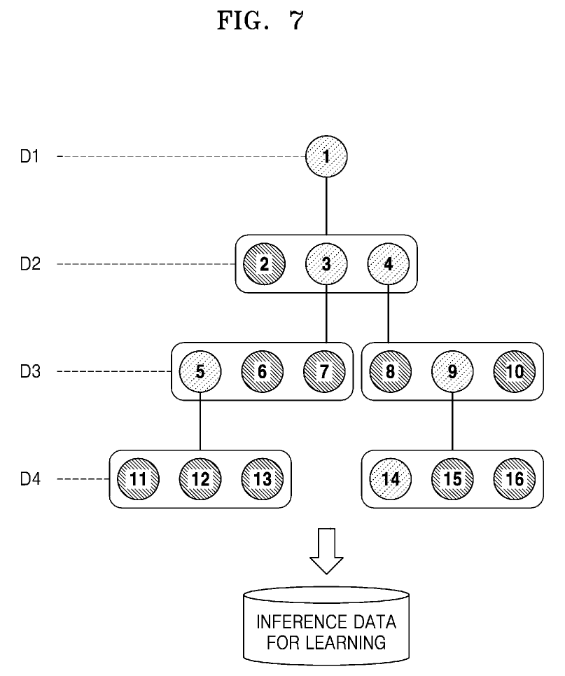

FIG. 7 schematically shows a process of performing a step of generating a branch node according to one embodiment of the present invention.

Schematically, the method for automatically generating inference data for learning may generate a plurality of branch nodes by applying each connector to an answer other than the correct answer among the answers derived from the LLM 2000, and form a tree by repeatedly applying each of the connectors to a branch node including an answer other than the correct answer among the plurality of branch nodes to generate a plurality of branch nodes, in which the plurality of branch nodes may be classified into a node including an answer which is the correct answer, and a node including an answer other than the correct answer.

In addition, branch nodes may be generated until the tree reaches a predetermined depth, and then a leaf node including an answer which is the correct answer may be detected among leaf nodes of the corresponding tree, and a path ranging from the detected leaf node to a root node may be configured as one set to derive inference data for learning.

As shown in FIG. 7, a tree shown in FIG. 7 may correspond to a tree generated for one first answer other than the correct answer, and the corresponding tree may include a plurality of branch nodes including nodes 1 to 16.

Specifically, with respect to the plurality of extracted task questions, the first answer other than the correct answer may be detected from among the first answers derived from the LLM 2000. After that, the plurality of branch nodes may be generated by applying each connector to the first answer other than the detected correct answer. In this case, node 1 may correspond to the branch node for one first answer other than the correct answer.

When a total of three connectors including connectors #1 to #3 exist in the server system 1000, each of the three connectors may be applied to the node 1 to derive the second answer, thereby generating each of nodes 2 to 4. For example, the second answer #1 may be derived by applying the connector #1 to the node 1. After that, the node 2 for the second answer #1 may be generated, the second answer #2 may be derived by applying the connector #2 to the node 1, the node 3 for the second answer #2 may be generated, the second answer #3 may be derived by applying the connector #3 to the node 1, and the node 4 for the second answer #3 may be generated.

Preferably, when each of connectors #1 to #3 is applied to node 1, different answers may be derived, and each connector may be classified into a connector for deriving an answer which is a correct answer and a connector for deriving an answer which is not the correct answer.

In this case, when the second answer #1 corresponding to the node 2 among the nodes 2 to 4 is the correct answer, the second answer #2 corresponding to the node 3 is not the correct answer, and the second answer #3 corresponding to the node 4 is not the correct answer, a branch node may be generated by deriving a third answer by additionally applying connectors to the node 3 and the node 4 corresponding to an answer other than the correct answer.

As shown in FIG. 6, nodes 5 to 7 may be generated by applying each of connectors #1 to #3 to node 3, and nodes 8 to 10 may be generated by applying each of connectors #1 to #3 to node 4. For example, the third answer #1 may be derived by applying the connector #1 to the node 3. After that, the node 5 for the third answer #1 may be generated, the third answer #2 may be derived by applying the connector #2 to the node 3, the node 6 for the third answer #2 may be generated, the third answer #3 may be derived by applying the connector #3 to the node 3, and the node 7 for the third answer #3 may be generated.

In one embodiment of the present invention, in case a second answer other than the correct answer is derived when the connector #1 is applied, it may have been performed after the connector #1 is already applied. Thus, two third answers may be derived by additionally applying each of the connectors #2 to #3, or three third answers may be derived by additionally applying each of the connectors #1 to #3.

In addition, when the third answer corresponding to each of nodes 6, 7, 8 and 10 among the nodes 5 to 10 generated as above is the correct answer, and the third answer corresponding to each of the nodes 5 and 9 is not the correct answer, the fourth answer may be derived by additionally applying connectors to the nodes 5 and 9 corresponding to the answer other than the correct answer, so as to generate the branch node.

In this case, nodes 11 to 13 may be generated by applying each of connectors #1 to #3 to node 5, and nodes 14 to 16 may be generated by applying each of connectors #1 to #3 to node 9. For example, the fourth answer #1 may be derived by applying the connector #1 to the node 5. After that, the node 11 for the fourth answer #1 may be generated, the fourth answer #2 may be derived by applying the connector #2 to the node 5, the node 12 for the fourth answer #2 may be generated, the fourth answer #3 may be derived by applying the connector #3 to the node 5, and the node 13 for the fourth answer #3 may be generated.

In one embodiment of the present invention, in case a third answer other than the correct answer is derived when the connector #1 is applied and the connector #2 is further applied, it may have been performed after the connectors #1 and #2 are already applied. Thus, one fourth answer may be derived by additionally applying connector #3, or three fourth answers may be derived by additionally applying each of the connectors #1 to #3.

Preferably, when an answer other than the correct answer is derived, the branch node may no longer be generated, and when an answer which is not the correct answer is derived, the connectors may be applied to additionally generate the branch node. Thus, the connectors may be repeatedly applied until an answer which is the correct answer is derived.

In addition, in FIG. 7, D1 to D4 may correspond to a depth of a tree or a depth of a corresponding branch node. For example, the tree shown in FIG. 7 may correspond to a tree having a total depth of 4, the depth of node 1 may correspond to 1, the depths of nodes 2 to 4 may correspond to 2, the depths of nodes 5 to 10 may correspond to 3, and the depths of nodes 11 to 16 may correspond to 4.

In one embodiment of the present invention, the branch nodes may be generated until the tree reaches a predetermined depth according to the server system 100 or a user' settings, and then a leaf node including an answer which is the correct answer may be detected from among leaf nodes of the corresponding tree, and a path ranging from the detected leaf node to a root node may be configured as one set to derive inference data for learning. Thus, the inference data for learning generated may vary according to the settings.

For example, when the predetermined depth corresponds to 4, as shown in FIG. 7, a branch node may be generated until the depth reaches 4. After that, the nodes 11, 12, 14, 15, and 16 including an answer which is the correct answer among the nodes 11 to 16 corresponding to the leaf node may be detected in the corresponding tree, and the path ranging from each of detected branch nodes to the root node may be configured as one set to derive inference data for learning.

In this case, in the case of the node 11, the nodes 11, 5, 3 and 1 may be configured as one set to derive inference data for learning, and in the case of the node 16, the nodes 16, 9, 4, and 1 may be configured as one set to derive inference data for learning. Thus, a total of five inference data for learning may be derived for each of the nodes 11, 12, 14, 15, and 16.

In addition, the plurality of branch nodes included in the tree may be classified into a node including an answer which is the correct answer and a node including an answer other than the correct answer, and in FIG. 7, the plurality of branch nodes may be classified into a branch node represented by hatched lines and a branch node represented by dots. Preferably, the branch node represented by hatched lines may correspond to a node including an answer other than the correct answer, and the branch node represented by dots may correspond to a node including an answer which is the correct answer.

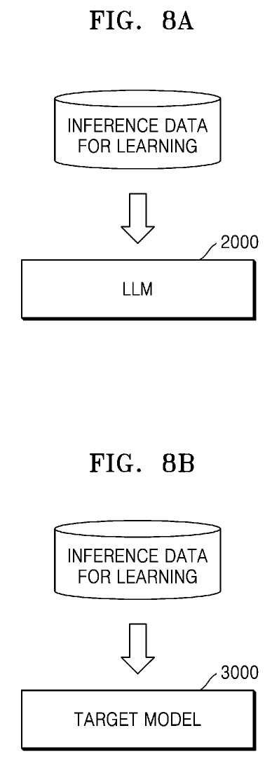

FIGS. 8A and 8B schematically show a process of performing a learning step according to one embodiment of the present invention.

Schematically, FIG. 8A may show a process of performing a step of training the LLM, and FIG. 8B may show a process of performing a step of training a target model 3000.

Specifically, the learning step may include training the LLM 2000 using the inference data for learning or training the target model 3000 other than the LLM 2000 using the inference data for learning.

As shown in FIG. 8A, the LLM 2000 may be trained using the derived inference data for learning. In this case, the LLM 2000 may correspond to the LLM which derives an answer including a first answer and a second answer, and the LLM 2000 trained through the inference data for learning may derive an accurate answer before learning when a question including a task question is input later, may derive an answer including a higher-quality inference content, or may automatically derive high-quality inference data.

As shown in FIG. 8B, the target model 3000 other than the LLM 2000 may be trained using the derived inference data for learning. In this case, the target model 3000 may be located outside or inside the server system 1000 and may correspond to a model including the LLM, the target model 3000 trained through the inference data for learning may derive an accurate answer before learning when a certain question is input later, may derive an answer including a higher-quality inference content, or may automatically derive high-quality inference data.

Preferably, the inference data for learning derived from the present invention may be high-quality inference data including an inference process, an inference content, and an inference result, and may be used as data capable of training various LLMs outside or inside the server system 1000.

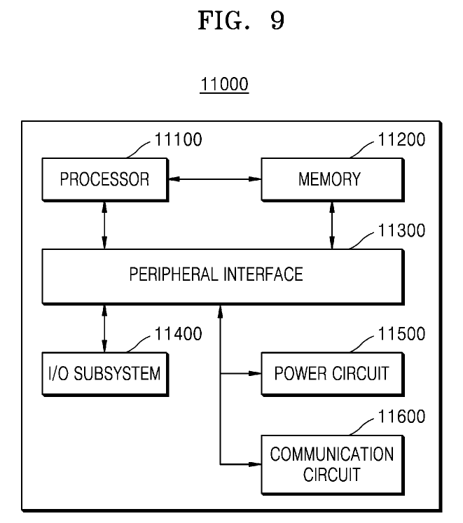

FIG. 9 schematically shows internal components of the computing device according to one embodiment of the present invention.

The computing device 1000 shown in the above-described FIG. 1 may include components of the computing device 11000 shown in FIG. 9.

As shown in FIG. 9, the computing device 11000 may at least include at least one processor 11100, a memory 11200, a peripheral device interface 11300, an input/output subsystem (I/O subsystem) 11400, a power circuit 11500, and a communication circuit 11600. The computing device 11000 may correspond to the computing device 1000 shown in FIG. 1.

The memory 11200 may include, for example, a high-speed random access memory, a magnetic disk, an SRAM, a DRAM, a ROM, a flash memory, or a non-volatile memory. The memory 11200 may include a software module, an instruction set, or other various data necessary for the operation of the computing device 11000.

The access to the memory 11200 from other components of the processor 11100 or the peripheral interface 11300, may be controlled by the processor 11100.

The peripheral interface 11300 may combine an input and/or output peripheral device of the computing device 11000 to the processor 11100 and the memory 11200. The processor 11100 may execute the software module or the instruction set stored in memory 11200, thereby performing various functions for the computing device 11000 and processing data.

The input/output subsystem may combine various input/output peripheral devices to the peripheral interface 11300. For example, the input/output subsystem may include a controller for combining the peripheral device such as monitor, keyboard, mouse, printer, or a touch screen or sensor, if needed, to the peripheral interface 11300. According to another aspect, the input/output peripheral devices may be combined to the peripheral interface 11300 without passing through the I/O subsystem.

The power circuit 11500 may provide power to all or a portion of the components of the terminal. For example, the power circuit 11500 may include a power failure detection circuit, a power converter or inverter, a power status indicator, a power failure detection circuit, a power converter or inverter, a power status indicator, or any other components for generating, managing, and distributing the power.

The communication circuit 11600 may use at least one external port, thereby enabling communication with other computing devices.

Alternatively, as described above, if necessary, the communication circuit 11600 may transmit and receive an RF signal, also known as an electromagnetic signal, including RF circuitry, thereby enabling communication with other computing devices.

The above embodiment of FIG. 9 is merely an example of the computing device 11000, and the computing device 11000 may have a configuration or arrangement in which some components shown in FIG. 9 are omitted, additional components not shown in FIG. 9 are further provided, or at least two components are combined. For example, a computing device for a communication terminal in a mobile environment may further include a touch screen, a sensor or the like in addition to the components shown in FIG. 9, and the communication circuit 11600 may include a circuit for RF communication of various communication schemes (such as WiFi, 3G, LTE, Bluetooth, NFC, and Zigbee). The components that may be included in the computing device 11000 may be implemented by hardware, software, or a combination of both hardware and software which include at least one integrated circuit specialized in a signal processing or an application.

The methods according to the embodiments of the present invention may be implemented in the form of program instructions to be executed through various computing devices, thereby being recorded in a computer-readable medium. In particular, a program according to an embodiment of the present invention may be configured as a PC-based program or an application dedicated to a mobile terminal. The application to which the present invention is applied may be installed in the computing device 11000 through a file provided by a file distribution system. For example, a file distribution system may include a file transmission unit (not shown) that transmits the file according to the request of the computing device 11000.

The above-mentioned device may be implemented by hardware components, software components, and/or a combination of hardware components and software components. For example, the devices and components described in the embodiments may be implemented by using at least one general purpose computer or special purpose computer, such as a processor, a controller, an arithmetic logic unit (ALU), a digital signal processor, a microcomputer, a field programmable gate array (FPGA), a programmable logic unit (PLU), a microprocessor, or any other device capable of executing and responding to instructions. The processing device may execute an operating system (OS) and at least one software application executed on the operating system. In addition, the processing device may access, store, manipulate, process, and create data in response to the execution of the software. For the further understanding, some cases may have described that one processing device is used, however, it is well known by those skilled in the art that the processing device may include a plurality of processing elements and/or a plurality of types of processing elements. For example, the processing device may include a plurality of processors or one processor and one controller. In addition, other processing configurations, such as a parallel processor, are also possible.

The software may include a computer program, a code, and an instruction, or a combination of at least one thereof, and may configure the processing device to operate as desired, or may instruct the processing device independently or collectively. In order to be interpreted by the processor or to provide instructions or data to the processor, the software and/or data may be permanently or temporarily embodied in any type of machine, component, physical device, virtual equipment, computer storage medium or device, or in a signal wave to be transmitted. The software may be distributed over computing devices connected to networks, so as to be stored or executed in a distributed manner. The software and data may be stored in at least one computer-readable recording medium.

The method according to the embodiment may be implemented in the form of program instructions to be executed through various computing mechanisms, thereby being recorded in a computer-readable medium. The computer-readable medium may include program instructions, data files, data structures, and the like, independently or in combination thereof. The program instructions recorded on the medium may be specially designed and configured for the embodiment, or may be known to those skilled in the art of computer software so as to be used. An example of the computer-readable medium includes a magnetic medium such as a hard disk, a floppy disk and a magnetic tape, an optical medium such as a CD-ROM and a DVD, a magneto-optical medium such as a floptical disk, and a hardware device specially configured to store and execute a program instruction such as ROM, RAM, and flash memory. An example of the program instruction includes a high-level language code to be executed by a computer using an interpreter or the like as well as a machine code generated by a compiler. The above hardware device may be configured to operate as at least one software module to perform the operations of the embodiments, and vice versa.

According to one embodiment of the present invention, there may be an effect of automatically generating inference data for learning using task datasets and connectors.

According to one embodiment of the present invention, there may be an effect of enabling self-learning of an LLM through inference data for learning.

According to one embodiment of the present invention, there may be an effect of deriving a corrected answer by applying a connector when the LLM derives an answer other than a correct answer for an inputted task question.

According to one embodiment of the present invention, there may be an effect of deriving inference data for learning when the LLM derives an answer which is the correct answer for the inputted task question.

According to one embodiment of the present invention, there may be an effect of learning the LLM and a target model using the inference data for learning.

According to one embodiment of the present invention, there may be an effect of generating a branch node by applying a connector to an answer other than the correct answer among the answers derived from the LLM.

According to one embodiment of the present invention, there may be an effect of generating a tree including the branch node based on a plurality of connectors, and deriving the inference data for learning based on the corresponding tree.

According to one embodiment of the present invention, there may be an effect of automatically generating inference data which satisfies diversity and quality using connectors.

According to one embodiment of the present invention, there may be an effect of developing a model with continuous performance on excellent inference through self-learning of the LLM.

Although the above embodiments have been described with reference to the limited embodiments and drawings, however, it will be understood by those skilled in the art that various changes and modifications may be made from the above-mentioned description. For example, even though the described descriptions may be performed in an order different from the described manner, and/or the described components such as system, structure, device, and circuit may be coupled or combined in a form different from the described manner, or replaced or substituted by other components or equivalents, appropriate results may be achieved.

Therefore, other implementations, other embodiments, and equivalents to the claims are also within the scope of the following claims.

What is claimed is:

1. A method for automatically generating inference data for learning using connectors, which is performed by a server system including one or more processors and one or more memories, the method comprising:
a task question extracting step of extracting a plurality of task questions from a task dataset including a task question and a task correct answer corresponding to the task question;
a first answer deriving step of deriving a first answer by inputting the extracted task question to an LLM outside or inside the server system;
a first answer verifying step of comparing the first answer with a task correct answer corresponding to the extracted task question to determine whether the first answer is a correct answer or not;
a second answer deriving step of deriving a second answer by inputting the task question, the first answer, and a first connector randomly determined among a plurality of predetermined connectors to the LLM when the first answer is not the correct answer; and
a second answer verifying step of comparing the second answer with the task correct answer to determine whether the second answer is the correct answer or not,
wherein the plurality of predetermined connectors include a phrase which induces the LLM to derive an inference process.

2. The method of claim 1, further comprising:
a third answer deriving step of deriving a third answer by inputting the task question, the first answer, the first connector, the second answer, and a second connector randomly determined among a plurality of predetermined connectors to the LLM when the second answer is not the correct answer; and
a third answer verifying step of comparing the third answer with the task correct answer to determine whether the third answer is the correct answer or not.

3. The method of claim 1, wherein the second answer verifying step includes configuring the task question, the first answer, the first connector, and the second answer as a set to derive inference data for learning when the second answer is the correct answer, and
the method further comprises a learning step of training at least one of the LLM and a target model other than the LLM using the inference data for learning.

4. The method of claim 1, further comprising:
detecting a task question, from which an answer other than the correct answer is derived, by inputting each of the plurality of task questions included in the task dataset to the LLM; and
deriving a corrected answer by applying each of the plurality of predetermined connectors to each of the detected task questions,
wherein the plurality of connectors are classified into a connector, which derives an answer which is the correct answer, and a connector, which derives an answer other than the correct answer, based on the corrected answer.

5. The method of claim 1, further comprising:
generating a plurality of branch nodes by applying each connector to an answer other than the correct answer among the answers derived from the LLM; and
forming a tree by repeatedly applying each of the connectors to a branch node including an answer other than the correct answer among the plurality of branch nodes to generate a plurality of branch nodes,
wherein the plurality of branch nodes are classified into a node including an answer which is the correct answer, and a node including an answer other than the correct answer.

6. The method of claim 5, further comprising:
generating branch nodes until the tree reaches a predetermined depth, and then detecting a leaf node including an answer which is the correct answer from among leaf nodes of the corresponding tree; and
configuring a path ranging from the detected leaf node to a root node as one set to derive inference data for learning.

7. A server system including one or more processors and one or more memories and configured to perform a method for automatically generating inference data for learning using a connector, the server system comprising:
a task question extracting module configured to extract a plurality of task questions from a task dataset including a task question and a task correct answer corresponding to the task question;
a first answer deriving module configured to derive a first answer by inputting the extracted task question to an LLM outside or inside the server system;
a first answer verifying module configured to compare the first answer with a task correct answer corresponding to the extracted task question to determine whether the first answer is a correct answer or not;
a second answer deriving module configured to derive a second answer by inputting the task question, the first answer, and a first connector randomly determined among a plurality of predetermined connectors to the LLM when the first answer is not the correct answer; and
a second answer verifying module configured to compare the second answer with the task correct answer to determine whether the second answer is the correct answer or not.

8. A non-transitory computer-readable storage medium storing computer-executable instructions that, when executed by a server system including one or more processors and one or more memories, cause the server system to perform operations for automatically generating inference data for learning using connectors, wherein the operations comprise:
a task question extracting step of extracting a plurality of task questions from a task dataset including a task question and a task correct answer corresponding to the task question;
a first answer deriving step of deriving a first answer by inputting the extracted task question to an LLM outside or inside the server system;
a first answer verifying step of comparing the first answer with a task correct answer corresponding to the extracted task question to determine whether the first answer is a correct answer or not;
a second answer deriving step of deriving a second answer by inputting the task question, the first answer, and a first connector randomly determined among a plurality of predetermined connectors to the LLM when the first answer is not the correct answer; and
a second answer verifying step of comparing the second answer with the task correct answer to determine whether the second answer is the correct answer or not.
